(19) United States
(12) Patent Application Publication
(10) Pub. No.: US 2008/0024593 A1
(43) Pub. Date: Jan. 31, 2008

(54) Multimedia Communication System

(76) Inventors: Larisa Tsirinsky, Rosh-Haain (IL); Alexander Ruditsky, Fair Lawn, NJ (US)

Correspondence Address: MYERS WOLIN, LLC, 100 HEADQUARTERS PLAZA, North Tower, 6th Floor, MORRISTOWN, NJ, 07960-6834, US

(21) Appl. No.: 11/779,872

(22) Filed: Jul. 18, 2007

Related U.S. Application Data
(60) Provisional application No. 60/820,253, filed on Jul. 25, 2006.

(51) Int. Cl. H04N 7/14

(52) U.S. Cl. 348/14.08; 348/E07.077

(57) ABSTRACT

A multimedia communication system for enabling a variety of high quality video applications over an internet protocol (IP) network is disclosed. In accordance with one embodiment, a videoconference can be established between participants equipped with a television centric multimedia communication system, without any PC computers or expensive videophone services. The participants may view each other on a display means, such as a large television screen. In accordance with another embodiment, the system allows mobile subscribers to migrate mobile video calls from a cellular network to an IP network.

### CROSS REFERENCE TO RELATED APPLICATIONS

This application claims the benefit of U.S. provisional application 60/820,253 filed on Jul. 25, 2006, which is hereby incorporated by reference for all that it contains.

### TECHNICAL FIELD

The present invention relates generally to video over IP applications, and more particularly to systems for enabling videoconferencing over IP networks.

### BACKGROUND OF THE INVENTION

In recent years, two or more ways video communication (or videoconferencing) between remote devices connected by a communication network, such as a local area network (LAN) or a wide area network (WAN) has become popular. Generally, conventional videoconferencing systems allow at least one participant to view another participant. For example, videoconferencing systems allow businesses to conduct “face-to-face” meetings between parties that are normally located remotely from each other. As a result, businesses have saved significant travel-related expenses that would have been otherwise incurred in order to conduct such face-to-face meetings.

The currently available high quality videoconferencing systems are costly and hence mainly targeted to the business markets. Specifically, most videoconferencing systems require the use of specialized hardware at either end of a point-to-point connection. In a typical scenario, videoconferencing equipment is installed in a dedicated videoconference room in a first location and in a similarly-dedicated videoconference room in a second location. Meeting participants are called to their respective rooms at a scheduled meeting time, and participants in each room are able to watch, over video, the other room during the meeting.

Low cost videoconferencing solutions for home users include webcams. Webcams have been proposed as a means to provide video images of participants in a meeting. A webcam may connect to a universal serial bus (USB) port of a personal computer (PC) and send a video stream to a browser that requests the images from the computer. Webcam functions are incorporated into Web-based conferencing applications such as those provided by Skype™, WebEX™, and the likes. The drawback of these applications, in comparison to high-cost solutions, is that such applications are configured to display a relatively low-resolution video on a PC's screen.

A videoconferencing session may also be established between mobile telephones, for example, over a 3G (third generation) cellular network. As a matter of fact, the usage of video telephony on 3G networks is only a small fraction of all services available on such networks. The reasons are the quality of the transmitted video and the high cost of videophone services.

In view of the foregoing discussion and the limitations of the prior art, it would be advantageous to provide a low-cost and high-quality video conferencing system.

### SUMMARY OF THE INVENTION

A television (TV) centric multimedia communication system (hereinafter the “TV-MCS”) for enabling a variety of high quality video applications over an internet protocol (IP) network is disclosed. In accordance with one embodiment, a videoconference can be established between participants equipped with the TV-MCS, without any computers or expensive videophone services. The participants may view each other on a display means, such as a large TV screen. In accordance with another embodiment, the TV-MCS allows mobile subscribers to migrate mobile video calls from a cellular network to an IP network.

### BRIEF DESCRIPTION OF THE DRAWINGS

FIG. 1—is block diagram of a TV-MCS (television (TV) centric multimedia communication system) disclosed in accordance with an embodiment of the present invention;

FIG. 2—is a diagram describing the process of establishing a videoconferencing session between two mobile telephones in accordance with an embodiment of the present invention;

FIG. 3—is a diagram describing the process of re-establishing a videoconference session between two mobile telephones in accordance with an embodiment of the present invention;

FIG. 4—is a diagram describing the process of establishing a videoconference session between a mobile telephone and an IP telephone in accordance with an embodiment of the present invention;

FIG. 5—is a diagram describing the process of establishing a videoconference session between a mobile telephone and a POTS videophone in accordance with an embodiment of the present invention;

FIG. 6—is a diagram describing the process of establishing a videoconference session between a plurality of TV-MCS in accordance with an embodiment of the present invention.

### DETAILED DESCRIPTION OF THE INVENTION

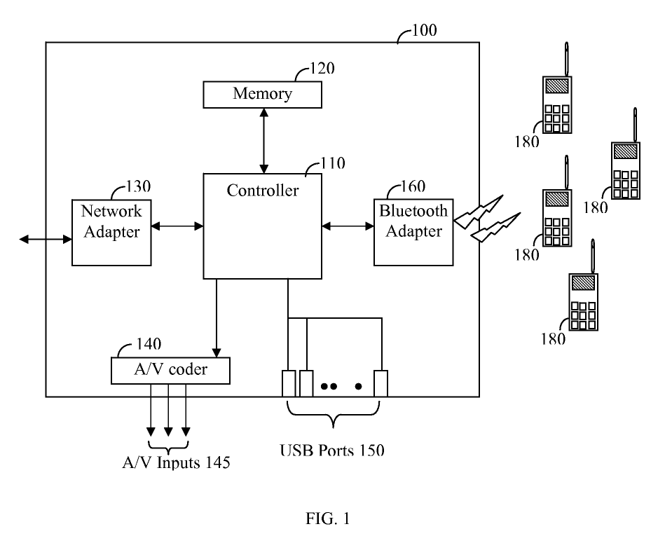

FIG. 1 shows an exemplary and non-limiting block diagram of a TV-MCS 100 disclosed in accordance with an embodiment of the present invention. The TV-MCS 100 includes a controller 110 coupled to a memory 120, a network adapter 130, an audio/video coder 140, a plurality USB ports 150, and a Bluetooth adapter 160.

The controller 110 controls the operation of the TV-MCS 100 components for the purpose of enabling high-quality video over IP applications. These applications include, but are not limited to, videoconferencing, instant messaging, pictures sharing, multimedia messaging service (MMS), and so on. The memory 120 may be from the type including, but not limited to, RAM, DRAM, a FLASH, or combination thereof. The memory 120 may contain provisioning information, addresses of TV-MCS (e.g., a phonebook), and files uploaded by the users. The network adapter 130 is configured to receive and transmit data packets from and to an IP network. The network adapter 130 may be connected to the network through a wired or wireless (e.g., Wi-Fi) connection. The audio/video coder 140 includes at least video and audio codecs for video compression or decompression of digital video and audio signals. In accordance with one embodiment of the present invention, the audio and video signals are compressed using at least the MPEG-4 or H.264 standards, and thereby allowing transmission of high-quality video images over an IP network with minimal bandwidth consumption. For example, the H.264 standard supports the transmission of high definition quality (1920×1080) video at rate of 1 MegaBit per sec.

A display, such as a screen of a TV set or a video monitor operable according to, for example, NTSC (National Television Standards Committee) or PAL (Phase Alternating Line) standards is connected to the TV-MCS 100 through A/V outputs 145. The USB ports 150 allow for the connection of TV-MCS 100 to at least one of a flash disk for uploading image files, a microphone, and a video camera. The controller automatically detects devices connected to USB ports according to conventional plug-and-play techniques. The video camera may be a webcam or other imaging input devices. It should be appreciated by a person skilled in the art that the microphone and/or video camera may be integrated within the TV-MCS 100, or be connected to the TV-MCS by means other than through USB ports.

The Bluetooth adapter 160 interfaces between handset devices 180 and the TV-MCS 100 for the purpose of initiating video calls through the IP network. A handset device 180 may be, but not limited to, a mobile telephone, a personal digital assistance (PDA), or any wireless or wired communication device which has voice capability and is compliant, for example, with the Bluetooth communication protocol. Other communication protocols such as ZigBee and the likes may be used for this communication purpose and are specifically included herein, however, the exemplary embodiment shall be described with respect to the Bluetooth communication protocol. Examples of such devices include code division multiple access (CDMA) based devices, time division multiple access (TDMA) based devices, a global system for mobile communications (GSM) based devices or 2G, 2.5G, or 3G enabled devices. The Bluetooth adapter 160 atomically recognizes and establishes a connection with the handset devices 180 that are in proximity with the TV-MCS 100. In addition, the Bluetooth adapter 160 atomically informs the controller 110 of handset devices that left the Bluetooth's coverage area. In some embodiments the Bluetooth adapter may interface with multimedia devices (e.g., a webcam, a headset, and the likes) that support the Bluetooth standard.

The TV-MCS 100 can be implemented in hardware, software, firmware, middleware or a combination thereof. In addition, the TV MCS 100 can be integrated within a set-top box, a DVD player, a TV set, with a PC screen, and the likes.

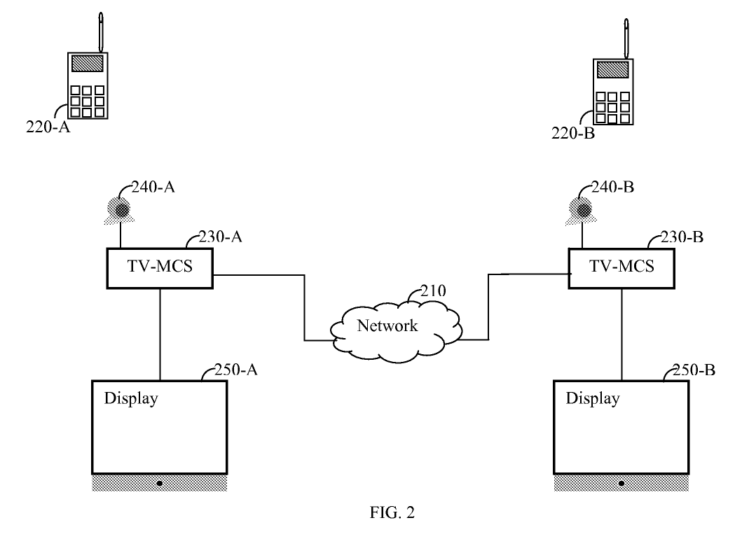

The operation of the TV-MCS 100 will be described in greater detail below with reference to several non-limiting embodiments of video over IP applications. FIG. 2 shows an exemplary diagram describing the process of establishing a videoconferencing session between two mobile telephones in accordance with an embodiment of the present invention. A videoconference is established between a mobile telephone 220-A of participant-A and a mobile telephone 220-B of participant-B over a network 210. The network 210 may be, for example, a LAN or a WAN. A mobile telephone 220 communicates with a TV-MCS 230 via a Bluetooth communication medium as defined by the telephony control protocol specification (TCS). Each TV-MCS 230 is coupled to a video camera 240, a display 250 and the network 210 having the attributes mentioned above.

Once participant-B enters the Bluetooth coverage area of the TV-MCS 230-B, the presence of the mobile telephone 220-B is automatically detected. Similarly, as participant-A enters the Bluetooth coverage area of the TV-MCS 230-A, the presence of the mobile telephone 220-A is it automatically recognized. Now, participant-A may call the mobile telephone 220-B of participant-B. Specifically, participant-A dials the number of the mobile telephone 220-B. The TV-MCS 230-A, in turn, captures the dialed number and calls TV-MCS 230-B using this number. The connection between TV-MCS 230-A and TV-MCS 230-B is established by means of communication standards that include, but are not limit to, H.323, session initiation protocol (SIP), or other proprietary protocols, the specifics of which are well known to those of ordinary skill in the art. For example, the TV-MCS 230-A may send the dialed number to a SIP server in the network 210. The SIP server may use electronic numbering (ENUM) or DUNDi to translate existing telephone numbers to SIP addresses using DNS. Once a session is established between TV-MCS 230-A and TV-MCS 230-B the video channel is opened between them.

The TV-MCS 230-B notifies mobile telephone 220-B of an incoming call. If participant-B decides to accept the call an audio channel is opened between mobile telephones 220 through TV-MC 230. Thereafter, participant-B may talk with participant-A over an audio channel established between mobile telephone 220-B, through TV-MCS 230-B, the network 210, and TV-MCS 230-A, and mobile telephone 220-A. Over the video channel, each TV-MCS 230 transmits high quality and high resolution video images captured by a video camera 240 and sends it to the other TV-MCS 230 that, in turn, displays the video images on display 250.

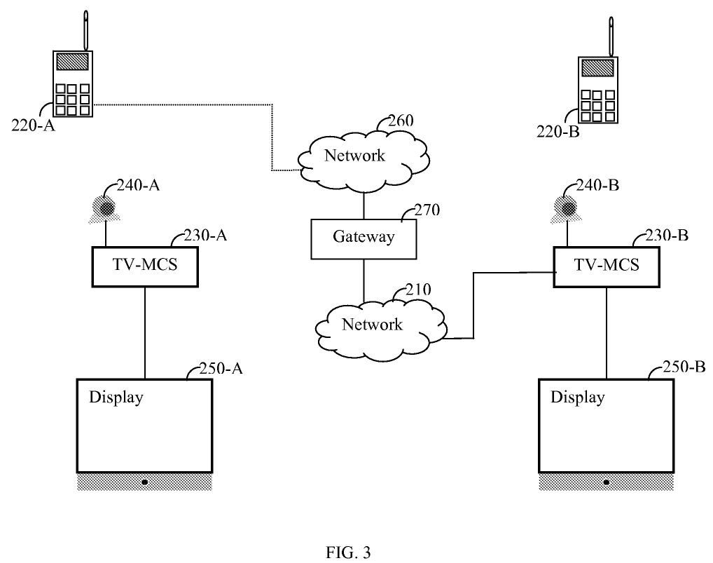

As illustrated in FIG. 3, as one of the participants (e.g., participant-A) leaves the Bluetooth coverage area of the TV-MCS 230-A, the Bluetooth connection with the mobile telephone 220-A is disconnected. Thereafter, the mobile telephone 220-A establishes a call leg with network 260, which may be, for example, a network compliant with the H.324M standard. The H.324M standard enables multimedia communication over low bit-rate networks (e.g., public switched telephone network (PSTN) or 3G cellular network). A voice call over an IP network is segmented into discrete call legs. A call leg is a logical connection between two gateways or between a gateway and an IP telephony device (e.g., a SIP server).

The network 260 communicates with the network 210 through a gateway 270 which may be, for example, a H.324M/SIP gateway. That is, the audio and video channels are opened between the mobile telephone 220-A and TV-MCS 230-B through the network 260, gateway 270 and network 210. Once the audio and video channels are established, the TV-MCS 230-A disconnects the connection with the network 210 (i.e., terminates the SIP connection). In this example, participant-A can view video images sent from participant-B over the screen of mobile telephone 220-A. On the other hand, participant-B can view video images recorded by a camera embedded in the mobile telephone 220-A over the display 250-B.

It should be appreciated by a person skilled in the art that the process described with reference to FIG. 3 can be utilized also to initiate a video call from a mobile telephone (e.g., telephone 220-B) that is connected through a Bluetooth communication medium to a TV-MCS (e.g., TV-MCS 230-B) and a stand alone mobile telephone (e.g., telephone 220-A) compliant with, for example, the H.324M standard. In this embodiment, the TV-MCS audio/video channels are established between the mobile telephones through the TV-MCS 230-B, the network 210, a gateway 270, the network 260 and mobile telephone 220-A. The TV-MCS 230-B and the gateway 270 communicate using, for example, the SIP communication standard.

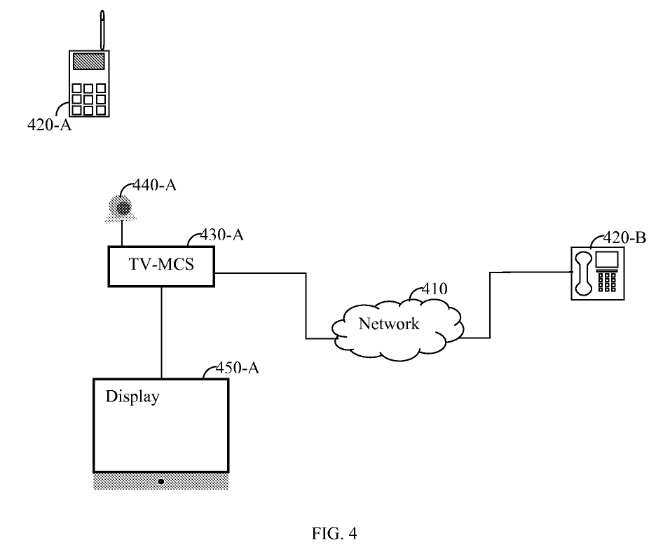

FIG. 4 shows an exemplary diagram describing the process of establishing a videoconference session between a mobile telephone and an IP telephone in accordance with an embodiment of the present invention. An IP telephone provides voice communication over the IP data network. Generally, such telephone includes functions much like a traditional analog telephone, allowing you to place and receive telephone calls.

In order to place a call participant-A, having a mobile telephone 420-A, enters the Bluetooth coverage area of a TV-MCS 430-A. Once the TV-MCS 430-A detects the presence of the mobile telephone 420-A, participant-A may dial the number of IP telephone 420-B. The TV-MCS 430-A establishes a videoconference session with mobile telephone 420-A through an IP network 410 using, for example, the SIP. The process for forming the session is described above. The audio channel is established between the mobile telephone 420-A, TV-MCS 430-A, IP network 410, and IP telephone 420-B. Over the video channel, the TV-MCS 430-A transmits high quality and high resolution video images captured by a video camera 440 to the IP telephone 420-B.

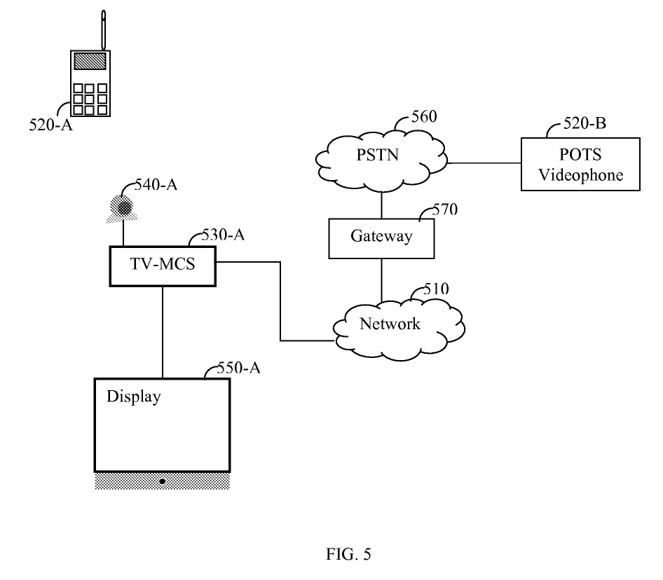

FIG. 5 shows an exemplary diagram describing the process of establishing a videoconference session between a mobile telephone and a Plain Old Telephone Service (POTS) videophone in accordance with an embodiment of the present invention. A POTS videophone is a telephone equipped for both audio and video transmission that uses the POTS telephone lines of a PSTN. In order to place a call participant-A, having a mobile telephone 520-A, enters the Bluetooth coverage area of the TV-MCS 530-A. Once the TV-MCS 530-A detects the presence of the mobile telephone 520-A, participant-A may dial the number of IP telephone 520-B. The TV-MCS 520-A, in turn, calls videophone 520-B using, for example, the SIP as described in detail above. The call from the mobile telephone 520-A to the videophone 520-B is routed through the TV-MCS 530-A, IP network 510, gateway 570, and PSTN 560. In one embodiment of the present invention, the gateway 570 is a PSTN/SIP gateway.

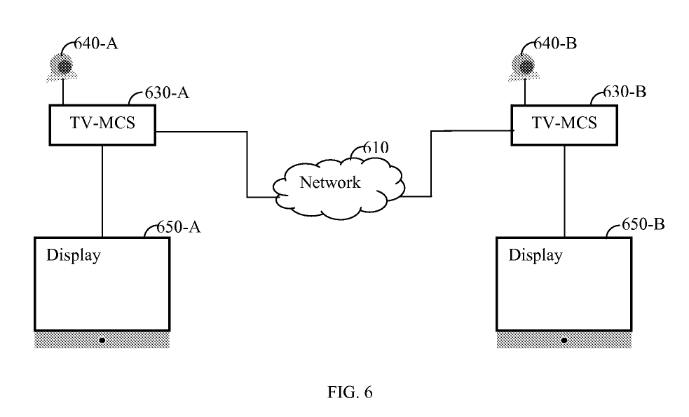

FIG. 6 shows an exemplary diagram describing the process of establishing a videoconference session between a plurality of TV-MCS in accordance with an embodiment of the present invention. For simplicity of the description, a videoconference established only between a TV-MCS 630-A and a TV-MCS 630-B is shown. Participant-A (not shown), who wants to call participant-B (not shown) has to designate the address of TV-MCS 630-B. Participant-A (not shown) may select the address from a phonebook stored in TV-MCS 630-A and displayed over display 650-A. Thereafter, a TV-MCS 630-A connects the TV-MCS 630-B through network 610 using the address provided by participant-A and videoconferencing session is between TV-MCS 630-A and TV-MCS 630-B using, for example, the SIP.

It should be noted that various modifications, combinations, sub-combinations and alterations of the above-described embodiments may occur, as required, insofar as they are within the scope of the appended claims or the equivalents thereof.

The principles of the present invention may be implemented as a combination of hardware and software. The software may be implemented as an application program tangibly embodied on a program storage unit or computer readable medium. The application program may be uploaded to, and executed by, a machine comprising any suitable architecture, for example a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown.

It is to be further understood that, because some of the constituent system components and methods depicted in the accompanying drawings are preferably implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention. All examples and conditional language recited herein are intended for pedagogical purposes to aid the reader in understanding the principles of the invention and the concepts contributed by the inventors to furthering the art, and are to be construed as being without limitation to such specifically recited examples and conditions.

All statements herein reciting principles, aspects, and embodiments of the invention, as well as specific examples thereof, are intended to encompass both structural and functional equivalents thereof. It is intended that such equivalents include both currently known equivalents as well as equivalents developed in the future, i.e., any elements developed that perform the same function, regardless of structure. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicants thus regards any means that can provide those functionalities as equivalent to those shown herein.

What is claimed is:

1. A communication system for enabling a variety of high quality video applications over an internet protocol (IP) network, the system comprises:
a network adapter for communicating with the IP network;
an audio/video (A/V) coder having video and audio codecs for compression or decompression of digital video and audio signals;
a wireless adapter for interfacing between a plurality of handset devices and the system; and
a controller for controlling the operation of the network adapter, the audio/video coder, and the wireless adapter.

2. The system of claim 1, further comprises:
a memory coupled to the controller, wherein the memory maintains at least provisioning information, a phonebook, and data files.

3. The system of claim 1, further comprises at least one media device, wherein the media device includes at least one of: a video camera and a microphone.

4. The system of claim 3, wherein the media device is connected to the system through at least one of: a universal serial bus (USB) port and the wireless adapter.

5. The system of claim 1, wherein the system is connected to a large screen display.

6. The system of claim 1, wherein the high quality video applications comprise at least one of: videoconferencing, instant messaging, pictures sharing, multimedia messaging service (MMS).

7. The system of claims 6, wherein a videoconferencing session is established between at least two mobile telephones, wherein each of the mobile telephones is connected to the system.

8. The system of claims 6, wherein a videoconferencing session is established between a mobile telephone and an internet protocol (IP) telephone, wherein the mobile telephone is connected to the system.

9. The system of claims 6, wherein a videoconferencing session is established between a mobile telephone and a plain old telephone service (POTS) videophone, wherein the mobile telephone is connected to the system.

10. The system of claims 6, wherein a videoconferencing session is established between at least two systems, wherein each of the system is connected to a video camera, a microphone, and a large screen display.

11. The system of claim 10, wherein an audio stream is sent from a mobile telephone over a wireless communication medium to the system and a video stream is generated by the video camera, wherein the wireless medium is compliant with at least one of: a Bluetooth communication protocol, and a ZigBee communication protocol.

12. The system of claim 1, wherein the audio and video signals are compressed and decompressed using at least one of: a MPEG-4 standard, and a H.264 standard.

13. A method for establishing a videoconferencing session between two mobile telephones over a network, comprising:
connecting a first mobile telephone with a television (TV) centric multimedia communication system (TV-MCS) via a wireless communication medium;
connecting a second mobile telephone with a television (TV) centric multimedia communication system (TV-MCS) via a wireless communication medium; and
forming a connection between the TV-MCS connected to the first mobile telephone and the TV-MCS connected to the second mobile phone through the network.

14. The method of claim 13, wherein the network is at least one of: a local area network (LAN) and wide area network (WAN).

15. The method of claim 14, wherein the connection between TV-MCS is formed using a communication protocol including at least one of: a H.323 protocol, and a session initiation protocol (SIP).

16. A method for establishing a videoconferencing session between a mobile telephone and an internet protocol (IP) telephone over a network, comprising:
connecting the mobile telephone with a television (TV) centric multimedia communication system (TV-MCS) via a wireless communication medium; and
forming a connection between the TV-MCS connected to the mobile telephone and the IP telephone through the network.

17. The method of claim 16, wherein the network is at least one of: a local area network (LAN), and a wide area network (WAN).

18. The method of claim 15, wherein the connection between the TV-MCS and the IP telephone is formed using at least a session initiation protocol (SIP).

19. A method for establishing a videoconferencing session between a mobile telephone and a plain old telephone service (POTS) videophone over a network, comprising:
connecting the mobile telephone with a television (TV) centric multimedia communication system (TV-MCS) via a wireless communication medium; and
forming a connection between the TV-MCS connected to the mobile telephone and the POTS videophone through a network.

20. The method of claim 19, wherein the connection between the TV-MCS and the POTS videophone is formed using at least a session initiation protocol (SIP).
